(19) United States
(12) Patent Application Publication
(10) Pub. No.: US 2020/0338665 A1
(43) Pub. Date: Oct. 29, 2020

(54) TOOL FOR PERFORMING A FRICTION STIR WELDING WITH A FRUSTOCONICAL PIN; METHOD FOR WELDING TWO PARTS USING SUCH A TOOL; WELDED PRODUCT

(71) Applicant: CONSTELLIUM ISSOIRE, Issoire (FR)

(72) Inventors: Thierry ODIEVRE, Voiron (FR); Jean-Pierre ARMENIO, Moirans (FR); Daniel BELLOT, Izeaux (FR)

(21) Appl. No.: 16/955,595

(22) PCT Filed: Dec. 20, 2018
(86) PCT No.: PCT/FR2018/053438

§ 371 Date: Jun. 18, 2020

(30) Foreign Application Priority Data
Dec. 22, 2017 (FR) 1763028

(51) Int. Cl. B23K 20/12

(52) U.S. Cl. CPC B23K 20/1255; B23K 2103/10

(57) ABSTRACT

The invention relates to a tool (1), intended for a friction stir welding station, the tool being capable of being rotated and including:
a body (10), defining a transverse surface, forming a shoulder (11);
a pin (12), extending, from the shoulder (11), along a longitudinal axis (Z), to an end (13), the pin (12) becoming slimmer between the shoulder (11) and the end, the distance between the end (13) and the shoulder (11) corresponding to a height of the pin (h).

### TECHNICAL FIELD

The technical field of the invention is friction stir welding. The invention particularly relates to the welding of thick parts along a great length. It can be applied to the manufacture of components, in particular components made of aluminium alloys, in particular for the aeronautics industry.

### PRIOR ART

Friction stir welding, usually designated by the acronym FSW, was developed in the 1990's. It is for example the object of documents WO93/10935 and WO95/26254. This technique consists of assembling two metal parts, disposed against one another, using a welding tool rotated with respect to the latter.

FIG. 1A shows a welding tool 1A according to the prior art. It is comprised of a main cylindrical body 10, defining a shoulder 11, and a pin 12A. The tool 1A can be rotated, the speed of rotation R being comprised between 100 and 1,500 revolutions per minute. FIG. 1B is a section showing two parts 21 and 22 maintained against one another, and resting on an anvil 25. The parts are clamped to one another, without clearance. The welding tool 1A is carried by a support 2 allowing the rotation thereof and the translation thereof along the parts. It is brought into contact with the parts to be welded, at an interface 23 extending between the two parts. In the start-up phase, the friction of the pin 12A on the parts generates a local heating, resulting in the softening of the material that forms the latter. The pin 12A then penetrates progressively into the parts, extruding the stirred material, until the shoulder 11 of the tool presses against said parts. The shoulder 11 then exerts a pressure on the parts 21 and 22, along the interface 23 thereof. The rotation of the shoulder, against the surface of the parts, generates friction that induces a local heating of the material, around the tool. Under the effect of the increase in temperature, the metal material comprising each part undergoes a plastic deformation, in the vicinity of the pin 12A. The kinetics of the pin drives a stirring of the softened material in the vicinity of the interface. The rotating tool is then translated along the interface 23, the speed of translation or advancing speed V being generally comprised between 30 mm/min and 500 mm/min. FIG. 1C shows a top view of FIG. 1B and shows the displacement of the welding tool along the interface 23, the movement of the tool combining a rotation at the speed of rotation R and a translation at the advancing speed V. The direction of rotation is indicated in FIGS. 1B and 1C, the tool rotating from the advancing side AS to the retreating side RS. The advancing side AS is the side where the local direction of the surface of the tool due to the rotation of the tool and the direction of welding are identical, the part (21) is located on the advancing side. The retreating side is the side where the local direction of the surface of the tool due to the rotation of the tool and the direction of welding are opposite, the part (22) is located on the retreating side.

The cooling of the stirred material forms a seam 24, or weld bead, along the interface 23. Thus, a weld is carried out little by little, without melting, by a metal/metal connection. The weld seam 24 is formed according to the progressive advancing of the tool along the interface. When the welding operation is completed, a removal phase makes it possible to remove the tool from the assembled parts. FIG. 1D is a photograph of a welding station. A support 2 is shown maintaining a welding tool 1A of which the pin 12A is introduced between the two plates 21 and 22. The welding tool 1A rotates and is translated, the axis of translation being the axis X shown in this figure.

A weld without filler metal is thus carried out, the seam 24 between the parts being formed only of the material that forms the assembled parts. Another advantage linked to FSW welding resides in the fact that the temperature is lower compared to the usual methods of welding; this improves the mechanical properties of the component resulting from the welding, and this reduces deformations. The method can also easily be automated, has little risk, and can make it possible to carry out welds of great thicknesses, over great lengths, in a single pass. When the welding parameters have been established, the repeatability of the quality of the weld constitutes another advantage of the method.

Friction stir welding is a promising technology for assembling aluminium parts. Applied to aluminium, friction stir welding is subject to the standard ISO EN 25239. It makes it possible to assemble high-resistance aluminium alloys, for example aluminium alloys of the 2000, 6000 and 7000 series.

In the field of aeronautics, this method constitutes an alternative to conventional means of fastening, such as riveting or bolting, for manufacturing components such as wing panels, ribs or fuselage panels. FSW welding is accompanied by a reduction in the mass of the component assembled, as well as savings in time to carry out the assembly. Outside of aeronautics, the method via FSW can have applications in the transport industry, in particular ship or rail transport as well the automobile.

FSW welding can relate to material other than aluminium, for example copper for the manufacturing of packaging intended to confine radiated nuclear fuel.

Many studies have been conducted with the purpose of optimising the performance of welding via FSW. These studies can address the shape of the tool and in particular that of the pin. Indeed, the pin conditions the stirring of the material and the circulation of the heated material. It is generally of cone shape. The optimisations of the pin to improve the quality of the welding substantially relate to the modification of the grooves and/or of the flat spots that can be arranged on the surface of said pin. The grooves form a thread on the surface of the pin in such a way as to generate currents of softened material in the vicinity of the pin. The flat spots extending along the pin mainly make it possible to improve the stirring.

The inventors have designed a specific shape of a rotating friction stir welding tool, that makes it possible to carry out a welding with improved performance. More precisely, one of the objectives sought is to carry out a welding of two thick parts, typically with a thickness greater than 20 or 25 mm, over a length of several metres, in particular greater than 10 metres, even greater than 15 metres in a single pass, i.e. without breakage or without a tool change over the entire length of the weld. This is the object of the invention described hereinafter.

### DISCLOSURE OF THE INVENTION

A first object of the invention is a tool, intended for a friction stir welding station, defined according to claim 1.

The tool is capable of being rotated and includes:
a body, preferably cylindrical, defining a transverse surface, forming a shoulder;
a pin, extending, from the shoulder, along a longitudinal axis, preferably perpendicular to the shoulder, to an end, the pin becoming slimmer between the shoulder and the end, the distance between the end and the shoulder corresponding to a height of the pin.

The pin can include:
a proximal portion, adjacent to the shoulder, and extending from the shoulder to the end, over at least 10% or 20% of the height of the pin;
a distal portion, adjacent to the end and extending from the end, to the shoulder, over at least 1% or 2% of the height of the pin, the distal portion being inscribed in a cone frustum, the cone frustum defining a cone surface, called the extension surface, extending the cone frustum to the shoulder, the extension surface delimiting a frustoconical volume.

The pin then extends to the outside of the frustoconical volume delimited by the extension surface.

“Being inscribed in a cone frustum” means being tangential to the cone frustum at different points distributed over at least 1% or 2% of the height of the pin. The distal portion is not necessarily located at the end of the pin. It can be distant by at least 1% or 2% or even 4% or more from the end but is necessarily located between the end and the proximal portion. The cone frustum, wherein the distal portion is inscribed, forms an envelope extending around the distal portion.

The transverse surface, forming the shoulder, can be planar, or curved with respect to a transverse plane, by forming an angle, with respect to the plane, less than 10°, even 5°.

Preferably, in the proximal portion:
the cone surface defines, in a radial cut plane, perpendicular to the longitudinal axis, a contour, in particular circular, advantageously centred around the longitudinal axis;
the pin has, in the cut plane, a perimeter in such a way that the perimeter extends around the circular contour.

In the proximal portion, the extension surface can describe an equation of the type x²+y²=z²(tan α)², the pin having a peripheral surface of which the points are such that x²+y²=k²(x,y,z), with k(x,y,z)²>z²(tan α)² where x, y are radial coordinates, in a radial plane perpendicular to the longitudinal axis, z is a coordinate along the longitudinal axis, k(x,y,z) is a scalar function that describes the peripheral surface, and a represents the half top angle defined by the cone frustum.

In the proximal portion, the pin can describe, in a plane parallel to the longitudinal axis, and passing through the latter, an outer surface extending along a portion of a curve, such that this curve is tangential to the extension surface. Preferably, the curve is also tangential to the shoulder. Preferably, the curve is an ellipse or a hyperbola or a parabola. The ellipse, the hyperbola or the parabola can then be tangential on the one had to the cone frustum wherein the distal portion is inscribed, and/or on the other hand to the shoulder.

In other terms, the pin describes an outer surface inscribed in an envelope describing, in a plane parallel to the longitudinal axis (Z) and passing through the latter,
in the proximal portion, a profile following a curve, preferably the curve being a portion of an ellipse or of a hyperbola or of a parabola;
in the distal portion, a profile according to a cone frustum and such that the curve is tangential to the cone frustum wherein the distal portion is inscribed, i.e. to the extension surface.

Preferably, the curve part of an ellipse or of a hyperbola or of a parabola is tangential to the extension surface.

Preferably, the curve is tangential to the shoulder. Preferably, the curve part of an ellipse or of a hyperbola or of a parabola is tangential to the shoulder.

Preferably, the curve is tangential to the extension surface and to the shoulder. Preferably, the curve part of an ellipse or of a hyperbola or of a parabola is tangential to the extension surface and to the shoulder.

The proximal portion can extend, from the shoulder, to 25% of the height of the pin, or to 33% of the height of the pin, or to 50% of the height of the pin. The distal portion can extend, from the end, to 2% of the height of the pin, or to 5% of the height of the pin, or to 10% of the height of the pin and even to 20 or 25%

In an embodiment, grooves are arranged on the surface of the pin in order to form a thread forming all or a portion of a helix or spiral helix extending between the end and the shoulder.

The filet can in particular be arranged to displace, during the welding, a softened material to the end of the pin. One or more flat spots can be arranged in the pin, the flat spot extending between the end and the shoulder.

The welding tool can in particular be configured to be disposed on a support in such a way as to be able to be rotated with respect to the latter, the support and the tool forming a welding head.

The pin and/or the body can in particular be formed from a material that is compatible with a use at high temperature and, preferably, a material chosen from:
a hardened steel, of the tool steel type, preferably having alloy elements of the nickel, chromium, molybdenum or vanadium type;
a tungsten alloy;
a nickel and cobalt alloy.

A second object of the invention is a method for friction stir welding of two parts, using a tool according to the first object of the invention, the method including the following steps:
maintaining parts against one another, in such a way as to define an interference between the parts;
rotating the tool and application of the tool at the interface, in such a way that the pin penetrates into the parts, until the shoulder of the tool is applied against the parts, by exerting a pressure on the latter;
translating the rotating tool thus disposed, along the interface, in such a way as to obtain a friction stir welding between the parts.

The parts are preferably manufactured from an aluminium alloy that can be identical or different between the two parts to be assembled.

The tool can be translated along a distance greater than 10 m, even greater than 15 metres or 20 metres, along the interface between the parts. The thickness of the parts is preferably greater than 20 mm or 25 mm or even 30 or 35 or 40 mm, the thickness extending along the longitudinal axis. The weld is preferably carried out in a single pass over the entire length of the interface between the two parts and can be carried out, when the parts to be assembled are particularly thick, for example of a thickness greater than 70 mm, on the two main faces of the parts. In this latter case, the weld is then preferably carried out in a single pass along the interface on each one of the main faces of the parts to be assembled. The weld can also be carried out according to an advantageous mode of the invention that is compatible with the preceding modes at a constant advancing speed V or at a pulsed advancing speed V as described in particular in document WO2010/004109.

A third object of the invention is a welded product carried out according to a method according to the second object of the invention, to weld two parts. Each one of the two parts can in particular be formed from an aluminium alloy, with the alloys of each one of the parts being identical or different.

Other advantages and characteristics will appear more clearly in the following description of particular embodiments of the invention, given as non-limiting examples, and shown in the figures listed hereinbelow.

### FIGURES

FIGS. 1A to 1F show a configuration of the prior art. FIG. 1A is a diagram of a welding tool.

FIGS. 1B and 1C show a welding tool acting at the interface between two parts to be welded, on one of the main faces thereof. FIG. 1D is a photograph of a welding station. FIGS. 1E and 1F show views of a welding tool.

FIGS. 2A to 2C show photographs of a tool of the prior art during an experimental test.

FIGS. 2D and 2E are graphs that represent temporal changes in the forces that are applied on a tool of the prior art, during an experimental test.

FIG. 3A diagrams respectively the geometries of the shape of a welding tool according to the prior art, as well as according to a first configuration, called the enlarged configuration, and according to a second configuration, called the elliptical configuration, with the latter being an application example of the invention.

FIG. 3B is a plane of the shape of a welding tool according to the first configuration. This welding tool is called “enlarged”.

FIG. 3C is a plane of the shape of a welding tool according to the second configuration. This welding tool is called “elliptical”.

FIG. 3D diagrams a section of the shape of a pin according to the invention, in a plane perpendicular to the longitudinal axis according to which the pin extends.

FIG. 3E shows a section of the shape of a pin according to the invention, in a plane parallel to the longitudinal axis according to which the pin extends, and passing through the longitudinal axis.

FIGS. 3F and 3G are two representations of a pin respectively according to the prior art and according to the invention.

FIGS. 4A, 4B and 4C are graphs that represent the temporal changes of the forces, measured experimentally, and respectively applying to:
the enlarged welding tool, according to the insertion of the pin into the interface between parts to be welded;
the elliptical welding tool, according to the insertion of the pin into the interface between the parts to be welded;
the elliptical welding tool, after having travelled a welding distance of 9 metres.

FIGS. 5A, 5B and 5C show a weld seam obtained by implementing the enlarged welding tool. FIG. 5A is a photograph of the seam, while FIGS. 5B and 5C are images resulting from an ultrasonic inspection (respectively C-scan, B-scan).

FIGS. 6A, 6B and 6C show a weld seam obtained by implementing the elliptical welding tool. FIG. 6A is a photograph of the seam, while FIGS. 6B and 6C are images resulting from an ultrasonic inspection (respectively C-scan and B-scan). FIGS. 6D and 6E are photographs of the elliptical welding tool before and after the carrying out of a weld over a length of 19 metres.

FIG. 7A diagrams a division of the material into four zones, resulting from the application of a FSW welding. FIGS. 7B and 7C are micrographs of sections of a component welded respectively with a tool of the prior art and with the elliptical tool.

### DISCLOSURE OF PARTICULAR EMBODIMENTS

“One” means “at least one”.

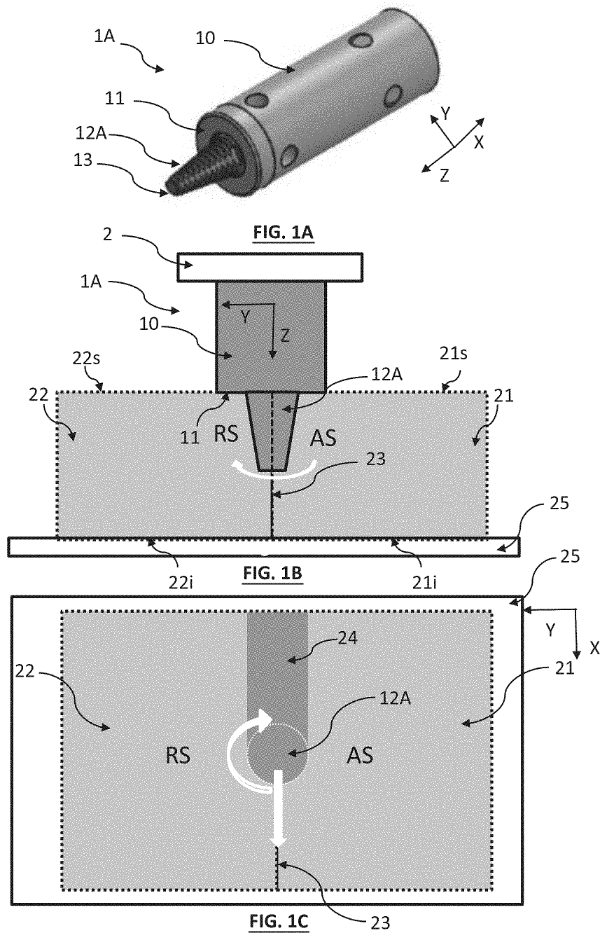

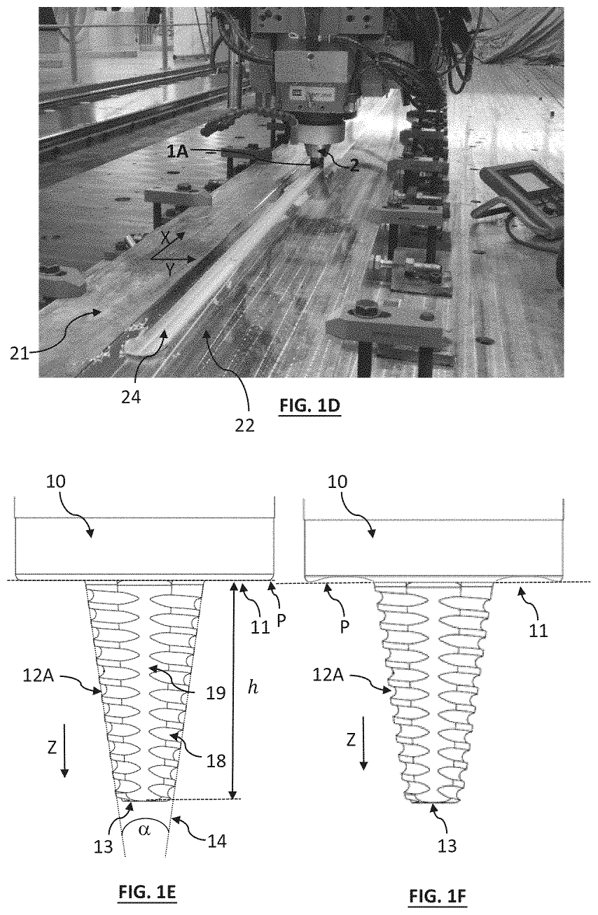

The inventors desired to apply a friction stir welding (FSW) in order to carry out components of aluminium alloy or alloys of great length and/or of great thickness. For this, they used a welding station of the prior art, such as shown in FIGS. 1A to 1F. Two aluminium alloy parts 21 and 22 in the shape of a plate have been clamped to one another, in such a way as to define an interface 23 extending over a length of 16 metres. The first part 21 is carried out according to an AA2050 alloy and the second part 22 is carried out according to an AA7140 alloy. The AA2050 and AA7140 alloys are in particular described in the document Registration Record Series—Teal Sheets—International Alloy Designations and chemical Composition Limits for Wrought Aluminium and Wrought Aluminium Alloys published by The Aluminum Association, in particular the version revised in January 2015. The thickness of each part is 68 mm. The thickness extends along a longitudinal axis Z, confounded with the longitudinal axis Z according to which the welding tool extends and, more precisely, the pin of the welding tool.

FIGS. 1A, 1B, 1E and 1F show the geometry of the welding tool used, the latter including a cylindrical body 10 defining a shoulder 11, as well as a pin 12A, as described in liaison with the prior art. The pin 12A is inscribed in a cone frustum 14, shown in FIG. 1E, and extending between the shoulder 11 and the end 13 of the pin. The height h of the pin corresponds to the distance, along the longitudinal axis Z, between the shoulder 11 and the end 13. In this example, it stands at 35 mm. It is generally comprised between 20 mm and 50 mm. The parts 21 and 22 extend respectively between a planar upper main face 21s, 22s and a planar lower main face 21i and 22i. To carry out a weld according to the thickness of the parts, the welding tool is successively applied on the main upper faces 21s and 22s, as shown in FIG. 1B, in order to carry out a first weld. It is then applied on the main lower faces 21i and 22i in order to carry out a second weld. The main upper and lower faces extend perpendicularly to the longitudinal axis Z. During the welding, the parts 21 and 22 rest on an anvil 25.

The material of the cylindrical body 10 is a tool steel of the H13 type according to the AISI (American Iron and Steel Institute) classification. The material of the pin is a cobalt and nickel alloy of the MP159 type (registered trademark). The nominal composition of this alloy is: Co: 35.7% (mass fraction); Ni: 25.5%; Cr: 19%; Mo: 7%; Ti: 3%; Cb: 0.6%; Al: 0.2%. The pin 12A is structured by a groove, forming a thread 18, arranged along the outer surface thereof, such a thread being shown in FIG. 1E. The thread makes it possible to improve the displacement of the softened material, in the vicinity of the pin, to the end 13 of the latter. A flat spot 19 can also be arranged along the outer surface. In the example shown, the pin includes three flat spots 19 angularly offset by 120°. In general, the depth of the thread or of the flat spot is less than 5 mm, by being for example comprised between 1 mm and 2 mm.

In FIG. 1E, the shoulder 11 extends along a plane P, perpendicular to the longitudinal axis Z according to which extends the pin 12A. FIG. 1F shows an alternative according to which the shoulder 11 extends substantially along the plane P, the term “substantially” designating the fact that the shoulder can be curved with respect to the plane P, according to an angular range of +10° or +5°.

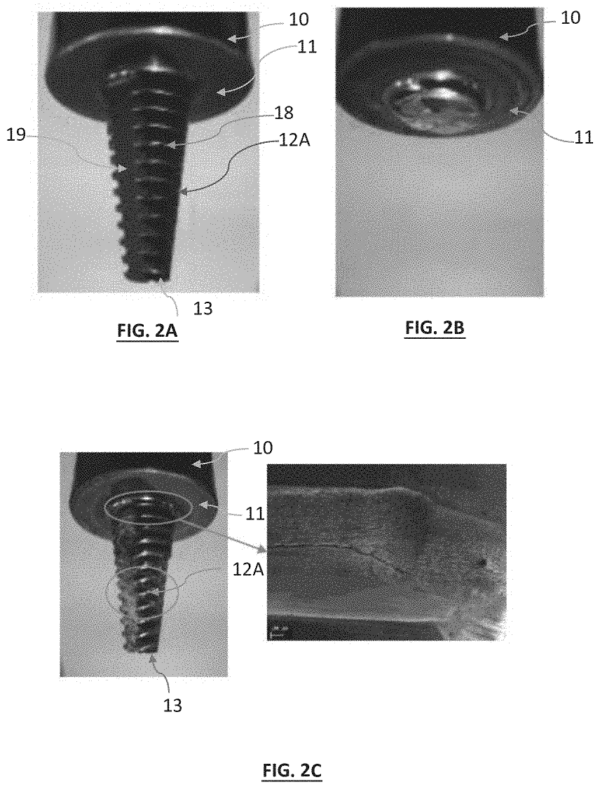

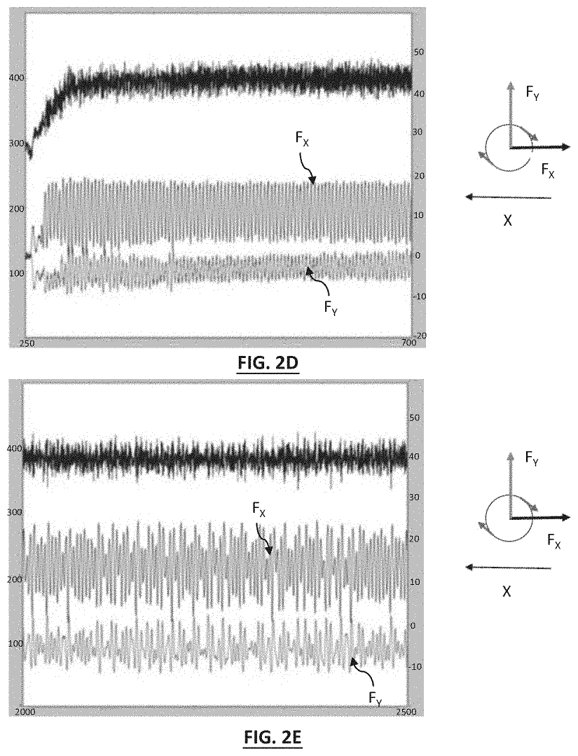

Experimental tests have been conducted using the welding station such as shown in FIG. 1D, with the speeds of rotation R and advancing V of the welding tool 10 being respectively between 180 and 220 revolutions per minute and 40 and 60 mm/min (average advancing speed). The tool used is photographed in FIG. 2A. The thread 18 and a flat spot 19 described in liaison with FIG. 1E have been identified in this figure.

The inventors have observed that the welding tool of the prior art is not suited for carrying out a weld over a great length. Indeed, after having carried out a weld over a length of 12 metres, the welding tool broke, at a base of the pin 12A, corresponding to the junction between the pin 12A and the shoulder 11. The welding tool is shown, after the welding, in FIG. 2B. FIG. 2C shows a welding tool of the same type, after having carried out a weld, in similar conditions, over a length of 5 metres. Cracks appear at the base of the pin, in the vicinity of the shoulder. These observations show that the welding tool of the prior art is not suitable for carrying out a weld when the length of the parts to be welded exceeds 10 metres.

During the carrying out of the weld, the welding tool is subjected to substantial mechanical stresses along the axis of translation, or advancing axis X, as well as according to the Y axis perpendicular to the axis of translation. Force transducers have been disposed on the support 2 maintaining the welding tool, in such a way as to measure the stresses that are exerted on the latter along the axis −X, opposite the axis of translation X, along the Y axis, as well as the resistance to rotation. FIGS. 2D and 2E show a temporal change in the forces Fx and Fy, respectively measured along the axes −X and Y, as well as the stress in rotation. In each one of these figures, the x-axis represents the time, expressed in seconds, while the y-axis represents the intensity of the forces Fx and Fy (right scale, expressed in N) and the stress in rotation (expressed in Nm, left scale). FIG. 2D shows the measurements between the insertion of the pin, corresponding to the abscissa t=250, to the abscissa t=700, which corresponds to a time internal of 450 seconds. The stresses that are exerted along the axis X, opposing the advancing direction X, are more substantial than those exerted along the axis Y, perpendicularly to the advancing direction, which was expected. FIG. 2E shows the measurements between the abscissas t=2,250 s and t=2,700 s, i.e. after a distance of about 9 metres travelled by the pin. It is observed that the signals corresponding to the force Fₓ, that are exerted opposite the direction of translation X, have substantial fluctuations, revealing a degradation of the welding tool. Substantial fluctuations are also observed that affect the forces that are exerted along the axis Y.

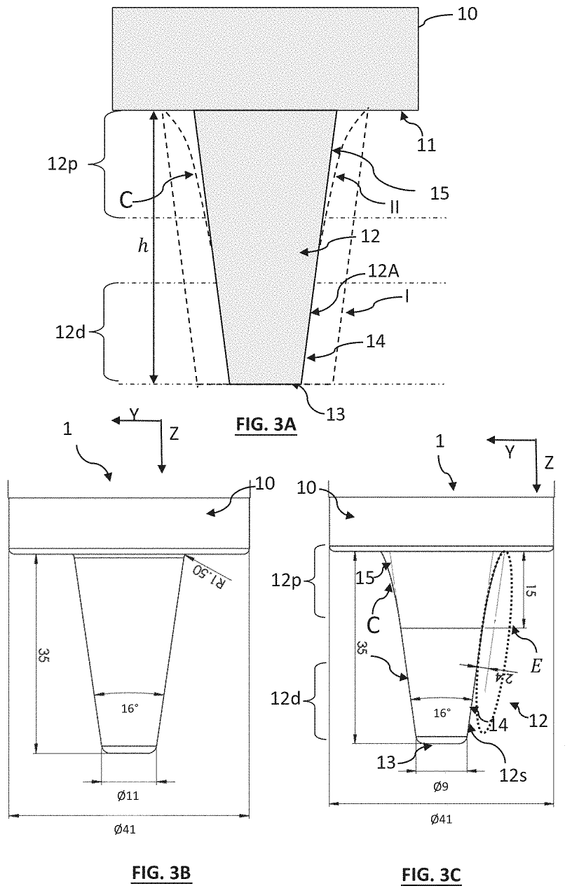

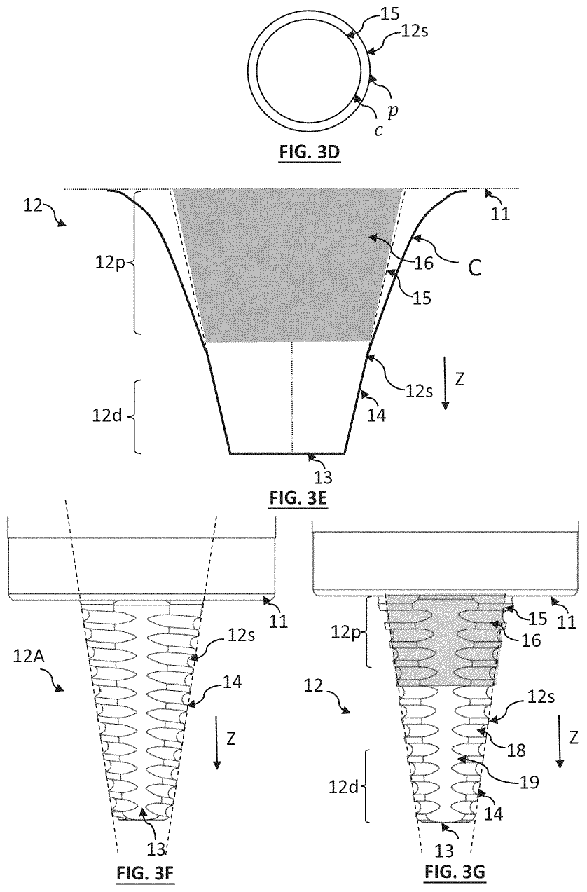

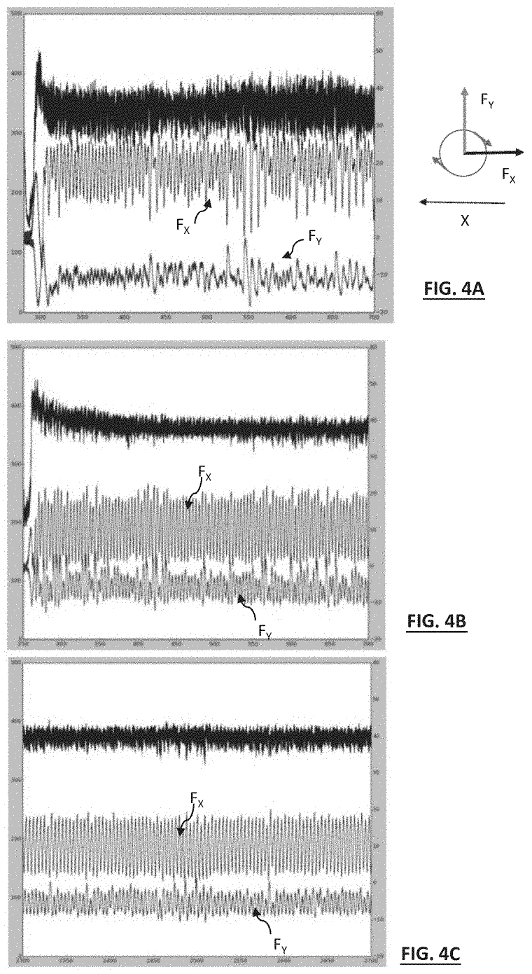

The inventors attribute the rupture of the welding tool to the fatigue resulting from the rotation. In order to render the welding tool compatible with a use over substantial distances, typically greater than 15 m, the inventors modified the shape of the pin, two options were considered. FIG. 3A shows the shape of the pin 12A according to the prior art, as well as a first configuration, called the enlarged configuration, according to which the pin 12 is wider than in the prior art (curve I). “Shape of a welding tool” means the envelope of said tool which does not take account of any flat spots and/or threading. According to the enlarged configuration, the diameter of the pin is increased 2 mm, uniformly, in such a way as to reinforce its mechanical strength. According to this configuration, the geometry of the pin is a cone, in that the pin is inscribed in a cone surface between the shoulder 11 and the end 13. FIG. 3A also shows a second configuration (curve II), called the elliptical configuration. According to this configuration, the diameter of the pin 12 is increased, with respect to the configuration of the prior art, only in one portion, called the proximal portion 12p, of the pin. The proximal portion of the pin corresponds to the portion of the pin extending between the shoulder 11 and a limit located at at least 10%, and advantageously 20% of the height h of the pin, and preferably at at least 25% of the height h of the pin or at at least 33% of the height h of the pin. The proximal portion 12p can extend to 50% of the height h of the pin, even to 75% of the height h of the pin or more. Preferably, the proximal portion 12p extends between 25% and 50% of the height h of the pin. The pin includes a distal portion 12d, extending from the end 13, to the shoulder 11. The distal portion extends over at least 1%, of the height h of the pin. Advantageously, the distal portion 12d extends to 2% of the height of the pin (h), or to 5% of the height of the pin, or to 10% of the height of the pin.

According to the second configuration, the pin 12 extends, in the distal portion 12d, by being inscribed in a cone frustum 14, in a manner similar to the prior art. The cone frustum 14 defines a frustoconical surface 15, called the extension surface, extending the cone frustum 14 to the shoulder 11, i.e. to the body 10. In the proximal portion 12p, the extension surface 15 delimits a frustoconical volume 16. In the proximal portion 12p, the volume of the pin extends beyond the frustoconical volume 16. Thus, in the proximal portion 12p, the pin widens, preferably progressively, in such a way that its outer surface 12s is located to the outside of the frustoconical volume 16 and follows a curve C. The frustoconical volume 16 is shown in grey in FIGS. 3E and 3G.

FIG. 3B is a plane of the pin of the first configuration tested (welding tool called “enlarged”). The pin takes a shape inscribed in a cone envelope, and widens in the vicinity of the shoulder 11, according to an arc of circle with a radius curvature of 1.5 mm. Thus, other than in the first 1.5 mm from the shoulder 11, the pin is inscribed in a cone surface. In this example, the cone surface extends by forming a half top angle of 8°. The diameter of the pin, at its end 13, is 11 mm, the latter being 9 mm in the configuration of the prior art.

FIG. 3C is a plane of the pin according to the second configuration tested, this configuration corresponding to an example embodiment of the invention (welding tool called “elliptical”). The diameter of the pin, in the distal portion 12d, corresponds to the diameter of the pin of the prior art. At the end 13, the diameter of the pin reaches 9 mm. According to this configuration, the pin is wider than the pin of the prior art only in the proximal portion 12p. In the proximal portion 12p, according to a median plane, parallel to the longitudinal axis Z and passing through the longitudinal axis, the outer surface 12s is inscribed along a curve C that takes an elliptical profile. This profile describes a part of an ellipse E of which the large axis is equal to 15 mm and of which the small axis is 2.4 mm. The ellipse E is shown in FIG. 3C, as a dotted line. In this example, the proximal portion 12p extends over a distance of 15 mm, from the shoulder 11, while the height of the pin stands at 35 mm. The proximal portion thus extends over about 40% of the height h of the pin. Thus, in the distal portion 12d, the outer surface 12s of the pin is inscribed in a cone frustum 14, of equation x²+y²=z²(tan α)², where x, y and z are coordinates respectively along the axes X, Y and Z and a is the half top angle of the cone frustum 14, here 8°. In the proximal portion 12p, the outer surface 12s describes an equation of type x²+y²=k(x,y,z)², with k(x,y,z)²>z²(tan α)². k(x, y, z) is a scalar function, describing the change in the outer surface 12s in the proximal portion 12p.

Preferably, the ellipse E is tangential to the extension surface 15 in such a way as to improve the flow of the material around the pin. The surface of intersection between the ellipse E and the extension surface describes preferably a circle, located in a plane perpendicular to the longitudinal axis Z. The surface of intersection can delimit the distal portion and the proximal portion.

Preferably, the ellipse E is tangential to the shoulder 11. Preferably, the ellipse E is tangential to the extension surface 15 and to the shoulder 11.

In the two configurations respectively shown in FIGS. 3B and 3C, the diameter of the pin, at the shoulder 11, is 24 mm.

If consideration is given to a cut plane perpendicular to the longitudinal axis Z, the extension surface 15 describes, in the proximal portion 12p, a circular contour c. The outer surface 12s of the pin 12 describes, in the cut plane, a perimeter p containing the circular contour c. In other words, along a cut plane perpendicular to the transverse axis Z, in the proximal portion 12p, the circular contour c of the extension surface 15 is included in the perimeter p of the pin 12. This is what is shown in FIG. 3D.

As can be seen in FIGS. 3E and 3G, in the proximal portion 12p, the pin is wider than the frustoconical volume 16 defined by the extension surface 15. Generally, in the proximal portion 12p, the outer surface 12s of the pin 12 has a larger diameter than the extension surface 15. As shown in FIG. 3E, the outer surface 12s is inscribed in an envelope describing, in a plane parallel to the longitudinal axis Z, and passing through the latter:
in the proximal portion 12p, a profile following a curve C, part of an ellipse or of a hyperbolae or of a parabola;
in the distal portion 12d, a profile according to a cone frustum 14.

Preferably, the profile according to a part of an ellipse or of a hyperbola or of a parabola is tangential to the extension surface 15. Preferably, the profile along a part of an ellipse or of a hyperbola or of a parabola is tangential to the shoulder 11.

FIG. 3E also shows the extension surface 15, extending the cone frustum 14 wherein is inscribed the pin in the distal portion 12d. Also shown is the frustoconical volume 16, delimited by the extension surface 15. In the proximal portion 12p, the pin 12 encompasses the frustoconical volume 16 and extends beyond the latter.

Preferably, the pin 12 is symmetrical with respect to the longitudinal axis Z.

The progressive widening of the pin, between the distal portion 12d and the shoulder 11, makes it possible to maintain a distal portion 12d that is relatively fine, while still reinforcing the pin 12 at the proximal portion 12p. FIGS. 3F and 3G show a pin respectively according to the prior art and according to the invention. In FIG. 3F, the outer surface of the pin 12A is inscribed in a cone frustum 14, shown as a dotted line. In FIG. 3G, in the distal portion 12d, the outer surface 12s of the pin is inscribed in a cone frustum. The cone frustum 14 is extended, in the proximal portion 12p, by the extension surface 15. A frustoconical volume 16 is shown, delimited by the extension surface 15. In the proximal portion 12p, the pin 12 extends beyond the frustoconical volume 16.

Regardless of the configuration, a thread 18 and/or a flat spot 19 can be arranged in the outer surface of the pin, in such a way as to guide the stirred material to the end 13, as described hereinabove in liaison with the pin of the prior art 12A.

The two configurations shown in FIGS. 3B and 3C were tested, according to experimental conditions similar to those described hereinabove, in liaison with the welding of two aluminium parts 21 and 22 in the shape of a plate 68 mm thick. FIG. 4A shows the temporal change of the forces measured according to the axis of translation X, according to the Y axis as well as the force in rotation, by using the tool according to the first configuration, called the “enlarged” configuration”. The axes and units are similar to those described in liaison with FIGS. 2D and 2E. In FIG. 4A, the insertion of the pin corresponds to the abscissa t=300 s. FIGS. 4B and 4C are similar to FIG. 4A and were obtained by implementing the second “elliptical” configuration. FIG. 4B corresponds to a time interval comprised between the insertion of the pin (abscissa t=250 s) and the abscissa t=700 s. FIG. 4C corresponds to a time interval comprised between the abscissa t=2,300 s and the abscissa x=2,700 s, with the distance travelled by the welding tool then being about 9 metres.

The comparison between the FIGS. 4A and 4B shows that by implementing the first configuration, the fluctuations are more substantial that by implementing the second configuration and this regardless of the effort examined. Moreover, FIG. 4C, shows that after having carried out a weld over a substantial distance, here 9 m, the behaviour of the welding tool, according to the second configuration, is stable: the fluctuations of the signals measured are comparable with those observed on the measurements taken when the distance travelled is low, cf. FIG. 4B. The comparison of FIG. 4C with FIG. 2E shows that with the second configuration, the signals measured, representing the forces exerted on the welding tool, are more stable. Thus, the welding parameters are stable, over a great length.

The second configuration was implemented in order to carry out a weld of plates 21 and 22, such as described hereinabove, over a length of 16 metres, without breaking the pin 12 of the welding tool. During another test, the weld length reached 19 metres.

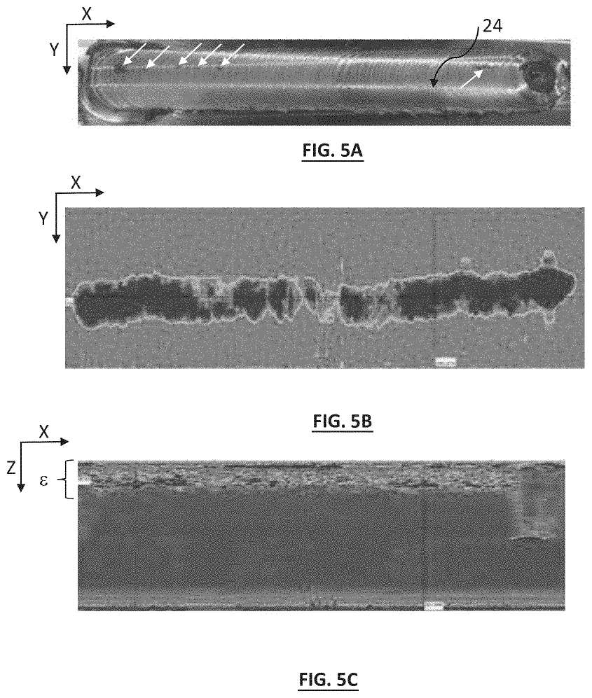

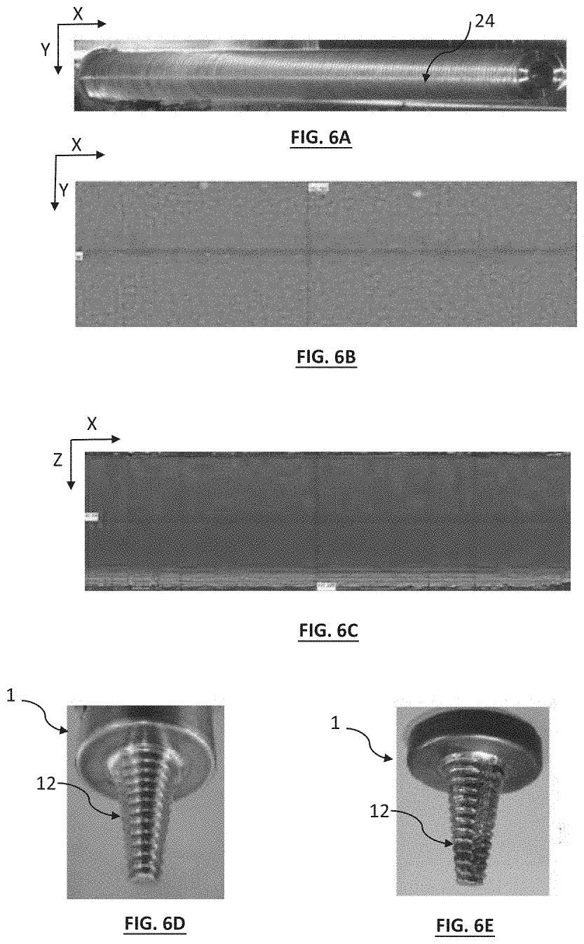

FIGS. 5A and 6A show the aspect of the weld seam 24 obtained by implementing respectively the first configuration and the second configuration, the length of the weld here reaching 350 mm. The weld seam obtained by implementing the first configuration has defects, appearing in the form of black lines, marked by the white arrows in FIG. 5A. In FIG. 6A, it is observed that the weld seam resulting from the second configuration is clearer.

FIGS. 5B and 5C are the results of an ultrasonic non-destructive structural inspection, implemented respectively along a transverse plane XY, above the weld seam 24 formed during the implementing of the first configuration, and along a section XZ, passing through the axis of insertion of the pin. FIGS. 5B and 5C reveal heterogeneities, bearing witness to the presence of porosities in the welded material, in particular in a thickness range ε of about 1 cm from the surface of the welded parts. Such a porosity is not acceptable in particular in welded parts used in the aeronautics industry. FIGS. 6B and 6C are similar to FIGS. 5B and 5C respectively and correspond to ultrasonic inspections on the weld seam 24 resulting from the implementing of the second configuration and shown in FIG. 6A. The porosities observed in FIGS. 5B and 5C are not present, or are clearly substantially lower, in FIGS. 6B and 6C. By implementing a pin according to the second configuration, the weld is more homogeneous and clearly has less porosities than according to the pin of the prior art.

FIGS. 6D and 6E respectively show the pin 12 of a welding tool according to the second configuration, after a weld carried out over a length of 16 m. Although traces of wear appear on the thread 18 arranged in the outer surface 12 s of the pin, the integrity of the latter is preserved.

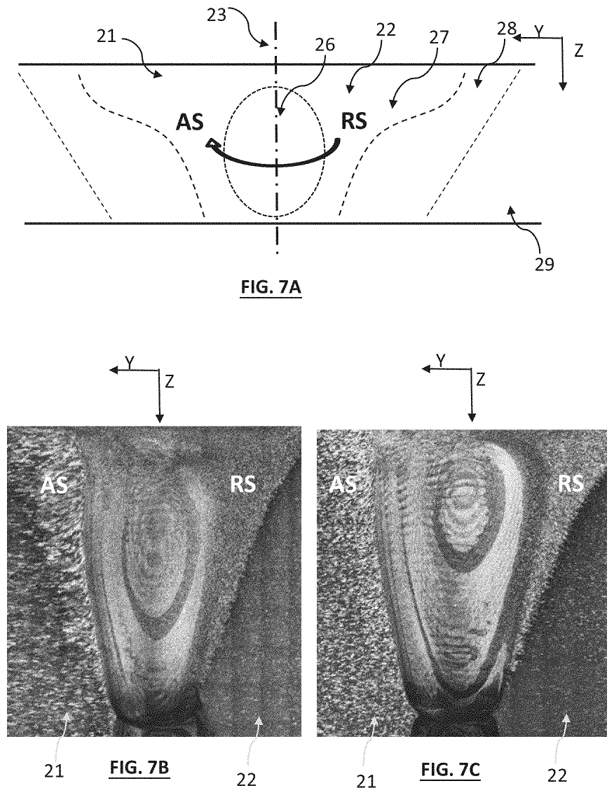

FIG. 7A shows a division of the welded material into four separate zones. At the interface 23, a central zone 26, called the core, corresponds in particular to the zone occupied by the pin 12 during the welding, as well as the immediately adjacent zone of the pin. It is in this portion that the plastic deformations are the most substantial and that the temperature is the highest. The core 26 is surrounded by a zone 27, called the thermo-mechanically affected zone, wherein the plastic deformation is moderate. In the vicinity of the thermo-mechanically affected zone extends a zone, called the thermally affected zone 28, wherein the properties of the material are affected only by the increase in temperature. This zone is delimited by a zone 29 including the base material, not deformed and not modified by the increase in temperature. FIG. 7A corresponds to a section along the plane YZ, the translation of the pin being made along the axis X. Along the plane XY, two separate sides are defined according to the direction of rotation of the pin. The advancing side AS is the side where the local direction of the surface of the tool due to the rotation of the tool and the direction of welding are identical, the part 21 is located on the advancing side. The retreating side is the side where the local direction of the surface of the tool due to the rotation of the tool and the direction of welding are opposite, the part 22 is located on the retreating side. FIGS. 7B and 7C are micrographs carried out on sections of components welded respectively by using a tool of the prior art and a tool that has a pin according to the second configuration tested. Note that the welding tool according to the invention (cf. FIG. 7C) makes it possible to obtain a more homogeneous distribution of the material. These figures reveal a flow of the material that is more homogeneous along the tool, more particularly in the zone close to the shoulder of the advancing side AS. The mechanical properties of the weld seam 24 are therefore improved.

The performance of the pin according to the second configuration is improved with respect to the pin of the prior art:
the robustness is increased, which makes it possible to carry out a weld over a greater length, typically greater than 10 m, 15 m or even 20 m, the thickness being greater than 20 mm, 25 mm or even 30, 35 or 40 mm.
the progressive widening, at the proximal portion, makes it possible to stabilise the mechanical stresses along the weld, leading to the obtaining of a weld seam that is more homogeneous.

The material that forms the welding tool is compatible with a use at high temperature. Reference can be made to the publication Rai R “Review: friction stir welding tools”, Science and Technology of Welding and joining, 2011, vol. 16 No. 4 325-342 to select the materials that can potentially be used. It can in particular be:
hardened steel, of the tool steel type, preferably having alloy elements of the nickel or chromium or molybdenum or vanadium type;
tungsten alloys;
nickel and cobalt alloys.

The invention will apply to the manufacturing of components of great length, for example components made of aluminium alloys intended for the aeronautics industry, and in particular components for the manufacturing of wings or fuselages.

1. Tool intended for a friction stir welding station, the tool being capable of being rotated and including:
a body, defining a transverse surface, forming a shoulder;
a pin, extending, from the shoulder, along a longitudinal axis, to an end, the pin becoming slimmer between the shoulder and the end, the distance between the end and the shoulder corresponding to a height of the pin (h);
the pin including:
a proximal portion, adjacent to the shoulder and extending from the shoulder, to the end, over at least 20% of the height of the pin (h);
a distal portion, adjacent to the end and extending from the end, to the shoulder, over at least 1% of the height of the pin (h), the distal portion being inscribed in a cone frustum, the cone frustum defining a surface, called the extension surface, extending the cone frustum to the shoulder, the extension surface delimiting a frustoconical volume;
in the proximal portion, the pin extends to the outside of the frustoconical volume delimited by the extension surface
wherein the pin describes an outer surface inscribed in an envelope describing, in a plane parallel to a longitudinal axis (Z) and passing therethrough,
in a proximal portion, a profile following a curve (C) and such that the curve (C) is tangential to the extension surface.

2. Tool according to claim 1 wherein, the profile of the curve (C) is tangential to the shoulder.

3. Tool according to claim 1, wherein, the curve (C) is a portion of an ellipse or of a hyperbola or of a parabola.

4. Tool according to claim 1, wherein the proximal portion extends to 25% of the height of the pin (h), or to 33% of the height of the pin, or to 50% of the height of the pin.

5. Tool according to claim 1, wherein a distal portion extends to 2% of the height of the pin (h), or to 5% of the height of the pin, or to 10% of the height of the pin.

6. Tool according to claim 1, wherein one or more grooves are arranged on the pin in order to form a thread forming all or a portion of a spiral helix extending between the end and the shoulder.

7. Tool according to claim 1, wherein at least one flat spot is arranged on the pin, the flat spot extending between an end and the shoulder.

8. Tool according to claim 1, configured to be disposed on a support in such a way as to be able to be rotated with respect thereto, the support and the tool forming a welding head.

9. Tool according to claim 1, wherein the pin and/or the body are formed from a material that is compatible with a use at high temperature, and optionally a material chosen from:
a hardened steel, of the tool steel type, optionally having alloy elements of the nickel or chromium or molybdenum or vanadium type;
and/or a tungsten alloy;
and/or a nickel and cobalt alloy.

10. Method for friction stir welding two parts, using a tool claim 1, the method comprising:
maintaining parts against one another, in such a way as to define an interference between the parts;
rotating the tool and application of the tool at the interface, in such a way that the pin penetrates into the parts, until the shoulder of the tool is applied against the parts, by exerting a pressure thereon;
translating the rotating tool thus disposed, along an interface, in such a way as to obtain a friction stir welding between the parts.

11. Method according to claim 10, wherein each one of the parts is formed by an aluminium alloy.

12. Method according to claim 10, wherein the tool is translated by a distance greater than 10 m, optionally even greater than 12 metres or 15 metres, along an interface between the parts.

13. Method according to claim 10, wherein the thickness of the parts being greater than 25 mm, optionally 30 mm, optionally 40 mm, the thickness extending along the longitudinal axis (Z).

14. Product welded using a method according to claim 10.
